(19) United States
(12) Patent Application Publication
(10) Pub. No.: US 2011/0166678 A1
(43) Pub. Date: Jul. 7, 2011

(54) ENTERTAINMENT SYSTEM AND METHOD INVOLVING CONVERSION OF WAVELENGTH SIGNALS TO AUDIO SIGNALS AND DEVICE RELATED TO THE SAME

(76) Inventor: KENNETH STETTER, JR., Lake Forest, CA (US)

(21) Appl. No.: 12/902,916

(22) Filed: Oct. 12, 2010

Related U.S. Application Data
(60) Provisional application No. 61/251,274, filed on Oct. 13, 2009.

(51) Int. Cl. G06F 17/00

(52) U.S. Cl. 700/94

(57) ABSTRACT

An entertainment system and method is provided that enables receiving of a sequenced sensor reading reflective of indicia in the visible spectrum on a rotating substrate and generating a sequenced audio signal reflective of the indicia. An operative system includes an operating circuit containing at least a photo sensor system and a converter operatively linked to a controlling processor system. A speaker is linked to the controlling processor system to generate the sequenced audio signals upon receipt of a digital signal from the processor. An operative electronic memory linked with the controlling processor system allows comparison of received signal data with a predetermined audio data set. The operative electronic memory also optionally stores multiple series of matched indicia and audio data sets, such that an entire musical song may be related to an externally recognizable image comprising such indicia in the visible spectrum.

### CROSS REFERENCE TO RELATED APPLICATIONS

This application claims priority from U.S. Provisional Patent Application Ser. No. 61/251,274, filed Oct. 13, 2009, the entire contents of which is herein incorporated fully by reference.

### BACKGROUND OF THE INVENTION

1. Field of the Invention

The present invention relates to an entertainment system and optional method involving conversion of wavelength signals to audio signals and a device related to the same. More specifically, the present invention relates to a playing entertainment device and system wherein a substrate carrying varied indicia is passed by a series of bandwidth-limited colored LEDs and a photo sensor in a housing operated by a system controller to produce audio signals.

2. Description of the Related Art

The related art involves audio sound generators in the form of digital video disks (DVD's) and previously known vinyl record players.

In these devices a rotating disk containing profile data in the form of raised or lowered profiles in a continuous stream of profile data is rotated past a stylus to generate a continuous series of vibration signals. These vibrational signals are thereafter amplified and released or transmitted via amplification to an electronic speaker.

What is not appreciated by the prior art is the currently inventive system of converting a series of visual indicia in the form of a contiguous image into a continuous stream of audio sound to support an entertainment system and method.

Accordingly, there is a need for an improved entertainment system and method involving conversion of wavelength signals to audio signals and device related to the same

### ASPECTS AND SUMMARY OF THE INVENTION

An aspect of the present invention is to provide an entertainment system that involves a colored indicia substrate.

Another aspect of the present invention is to provide a playing entertainment device and system wherein a substrate carrying varied indicia is passed by a series of bandwidth-limited colored LEDs and a photo sensor in a housing operated by a system controller to produce audio signals.

According to one alternative embodiment of the present invention, there is provided an electronic device, comprising: a processing control module in a housing member, the housing member containing a rotating support and means for driving the rotating support past a location containing a means for photo sensing a series of reflected sequenced light flashes resulting from a plurality of known wavelength-limited LED's outputting sequenced light incident on a colored substrate rotating on the rotating support during a use, at least one speaker system for receiving an audio generation signal and generating an output note, the processing control module comprising a memory module containing a database for receiving timed sequenced intensity information in a series of sequences and comparing the timed sequenced intensity information to a stored table and selecting a reflective color designation, and the processing control module determining, from the reflective color designation a related musical note audio tone and generating an audio generation signal to the speaker to generate the output note.

According to another embodiment of the present invention, there is provided an electronic device, further comprising: a reader arm member containing the means for photo sensing, a first drive motor for operating the reader arm member in an arc relative to the rotating support and the colored substrate during a use thereof, a second drive motor for operating the rotating support during the use, and a plurality of trigger members interlinked with the processing control module and respective the first and second drive motors operating the electronic device during the use, whereby the entertainment system enables the entertainment use.

According to one alternative embodiment of the present invention, there is provided an entertainment system, comprising: a plurality of indicia substrates containing a plurality of color-indicating regions and for receiving a color designation during a coloring use thereof, each the indicial substrate containing a contiguous indicia designation different from others of the plurality of indicial substrates, a processing control module in a housing member, the housing member containing a rotating support and means for driving the rotating support past a location containing a means for photo sensing a series of reflected sequenced light flashes resulting from a plurality of known wavelength-limited LED's outputting sequenced light incident on a colored one of the indicial substrates rotating on the rotating support during a use, at least one speaker system for receiving an audio generation signal and generating an output note, the processing control module comprising a memory module containing a database for receiving timed sequenced intensity information in a series of sequences and comparing the timed sequenced intensity information to a stored table and selecting a reflective color designation, and the processing control module determining, from the reflective color designation a related musical note audio tone and generating an audio generation signal to the speaker to generate the output note.

According to another embodiment of the present invention, there is provided an entertainment system, further comprising: a reader arm member containing the means for photo sensing, a first drive motor for operating the reader arm member in an arc relative to the rotating support and the colored substrate during a timed use thereof, a second drive motor for operating the rotating support during the use, and a plurality of trigger members interlinked with the processing control module and respective the first and second drive motors operating the electronic device during the use, whereby the entertainment system enables the entertainment use.

According to another embodiment of the present invention, there is provided a method of generating a sound comprising the steps of: providing an operating system containing a housing, a rotating support member on the housing, and a photo sensing system positioned proximate the rotating support member, providing in the photo sensing system at least one bandwidth limited LED for generating an incident known wavelength at a sequenced timing relative to a use thereof via a processor controller, providing the processor controller in operative control of the operating system, the rotating support, the photo sensing system and the at least one bandwidth limited LED, the process controller including an electronic memory for storing known reflected intensity measurements relative to received reflective light received by the photo sensing system, providing at least one colored indicia indicated substrate having a contiguous image thereon and a plurality of related regions for receiving external coloring thereon, coloring selected ones of the selected regions with the external coloring so as to form a colored contiguous color indicia image thereon, placing the substrate on the rotating support, rotating the substrate on the rotating support past the photo sensing system and triggering the LED to generate a flashed sequenced known to the processor controller and receiving reflected intensity values from the flashed sequence, and converting the reflected intensity values to an audio note via access of a stored color/note data table and generating an audio digital signal to at least one speaker.

According to another embodiment of the present invention, there is provided an entertainment system and method is provided that enables receiving of a sequenced sensor reading reflective of indicia in the visible spectrum on a rotating substrate and generating a sequenced audio signal reflective of the indicia. An operative system includes an operating circuit containing at least a photo sensor system and a converter operatively linked to a controlling processor system. A speaker is linked to the controlling processor system to generate the sequenced audio signals upon receipt of a digital signal from the processor. An operative electronic memory linked with the controlling processor system allows comparison of received signal data with a predetermined audio data set. The operative electronic memory also optionally stores multiple series of matched indicia and audio data sets, such that an entire musical song may be related to an externally recognizable image comprising such indicia in the visible spectrum.

The above, and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a top perspective view of the proposed system.

FIG. 2 is a top plan view of the proposed system in FIG. 1.

FIG. 3 is a top plan transparency view of the proposed system in FIG. 1 showing internal driving component position, location of arm return motor and position control switches that modulate control arm motion.

FIG. 4 is a partial cut away view of an arm housing and arm of the present invention.

FIG. 5 is an exemplary image of a partially colored indicia substrate for use in the proposed system, wherein a contiguous image contains a plurality of defined regions for receiving a desired color to form the contiguous image.

FIG. 6 is another exemplary image of an uncolored indicia substrate for use with the proposed system containing a contiguous image and a plurality of defined regions for receiving a desired color to form the contiguous image.

FIG. 7 is another exemplary image of an uncolored indicia substrate for use with the proposed system containing a contiguous image and a plurality of defined regions for receiving a desired color to form the contiguous image.

FIG. 8 is a flow diagram providing alternative use routes for the proposed system.

FIG. 9 is an exemplary circuit design for the proposed system.

FIG. 10 is an exemplary table marker color analysis indicating how a proposed note designation may correspond with a determined color value in the electromagnetic spectrum based upon received reflected values of light from LED souses.

FIG. 10A is an exemplary graphical representation corresponding to FIG. 10, wherein a corresponding color is graphically represented relative to the intensity of color received from corresponding LEDs following reflection from the colored indicia substrate.

FIG. 11 is an exemplary graphical and tabular assembly indicating an ability to differentiate multiple colors and marks based upon varied intensity levels received by the proposed system.

FIG. 12 is an exemplary flow diagram reflecting one aspect of the proposed operation of the inventive system.

### DETAILED DESCRIPTION OF THE PREFERRED EMBODIMENTS

The novel features that are considered characteristic of the invention are set forth with particularity in the appended claims. The invention itself, however, both as to its structure and its operation together with the additional and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. 112, paragraph 6 to define the invention. To the contrary, if the provisions of 35 U.S.C. 112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. 112, paragraph 6. Moreover, even if the provisions of 35 U.S.C. 112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

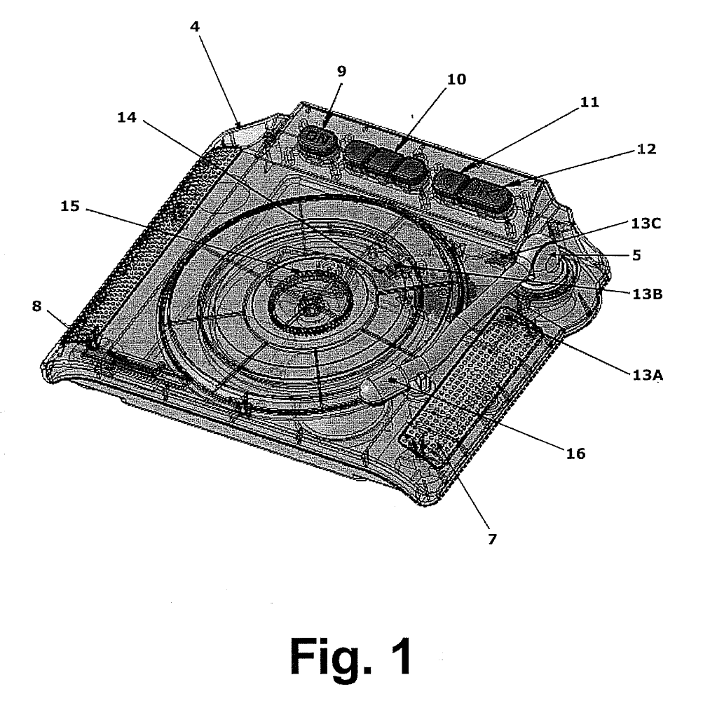

Referring now to FIGS. 1, 2, and 3, an entertainment system 1 contains a housing 4 and an operating control arm or arm 2 operating through an arc relative to a pivot system 5. During operation a rotational support disk 6 having a rotational center 6A rotates relative to housing 4. Arm 3 pivots through a preferred number of arc degrees relative to an edge (shown) and rotational center 6A of disk 6. A preferred rotational arc is between 5 and 30 degrees. A more preferred rotational arc for arm 2 is between 5 and 10 degrees, and a most preferred rotational arc is approximately 8 degrees.

Those of skill in the art, having studied the enclosed disclosure and description will understand that the proposed system 1 may be embodied in alternative housings and alternative details without departing from the scope and spirit of the present invention. For example, pivoting arm 2 may be replaced by a sliding arm or reader head without departing from the scope and spirit of this disclosure.

Housing 4 includes a pair of speakers 7, 7. A volume control system 8 allows a sliding or other adjustment of the audio out put of speakers 7, 7. Across a raised location spanning speakers 7, 7, a series of electronic control buttons is arrayed. As shown, there is an on/off button 9, a series of selection buttons 10, shown as 10A (piano), 10B (horn), and 10C (violin), enable a user to select the tone of the produced audio notes projected. As will be later described, a user may select a piano 10A sound for the sound reproduced. Other tones or recognized instrument sounds or tones (trumpets, horns, drums, flutes, etc.) may be provided without departing from the scope and spirit of the present invention.

Also provided is an arm control return button 11 which can supersede the action of arm or control arm 2 causing immediate return or use. A designated controller play/pause button 12 is also provided allowing operational control of rotating support disk 6.

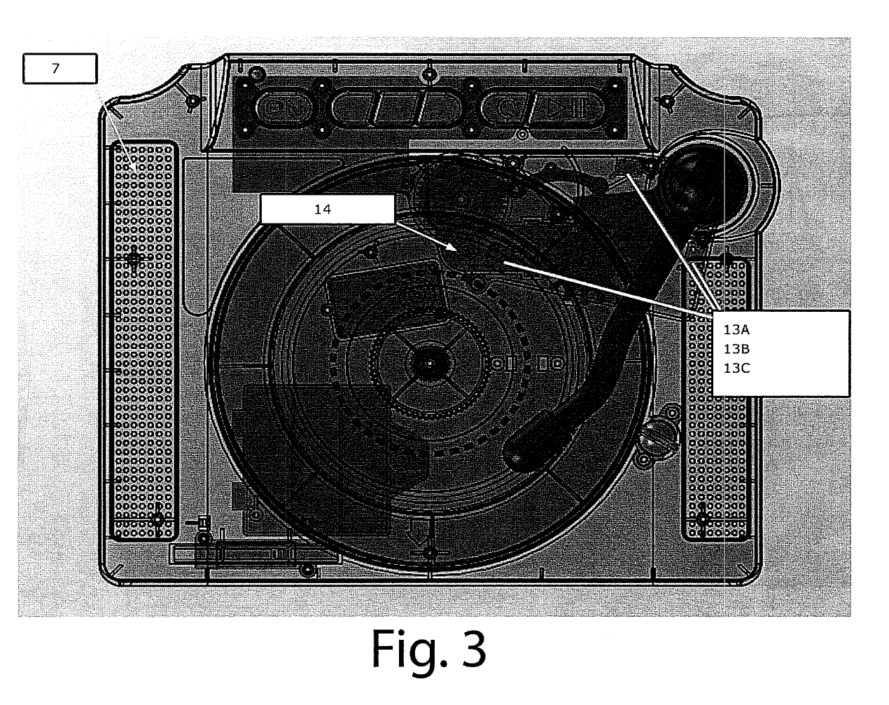

As can be seen in FIGS. 1 and 3, a set of three positional switches 13A, 13B, and 13C function as leaf switches to control the position of arm 2 relative to support disk 6. An arm return motor 14 is in operational control with return button 11 for control of arm 2. An additional motor 15 within housing 4 functions as a drive turn table motor so as to allow support disk 6 to function and rotate in use.

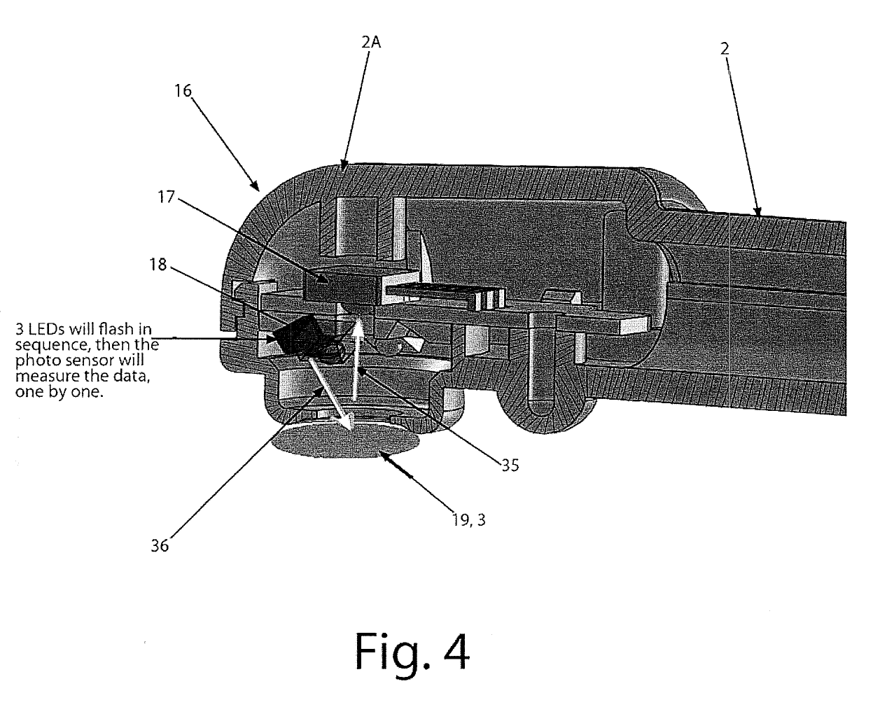

Additionally referring now to FIG. 4, control arm 2 includes an arm housing member 2A at a distal end spaced from pivot system 5. A color sensor system 16 contains a photo sensor IC 17 and an array of three limited-bandwidth different colored LED light sources 18, 18, 18. The proposed LED light sources are blue, red, and yellow LED's, but the proposed system 1 may be arranged to optionally accept other color LED arrangements with sufficient modification. Such modification will be recognized by those of skill in the art as being within the instant disclosure, now that they have studied the same. During operation, the three LED's 18, 18, and 18 will flash in sequence and sensor 17 will record or measure the intensity of the data for each flash in sequence. A surface 19 of colored indicia substrate 3 is shown as the measuring surface. This operation will be discussed in further detail below.

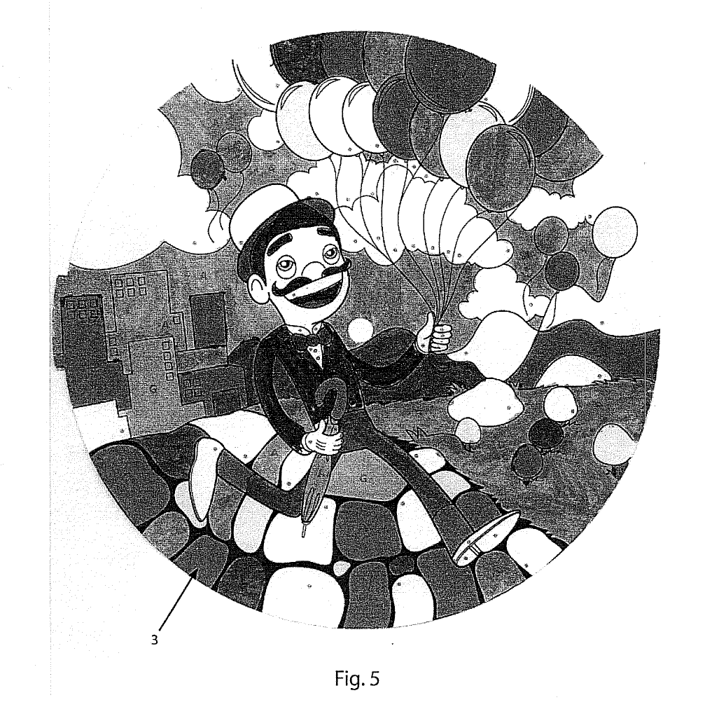

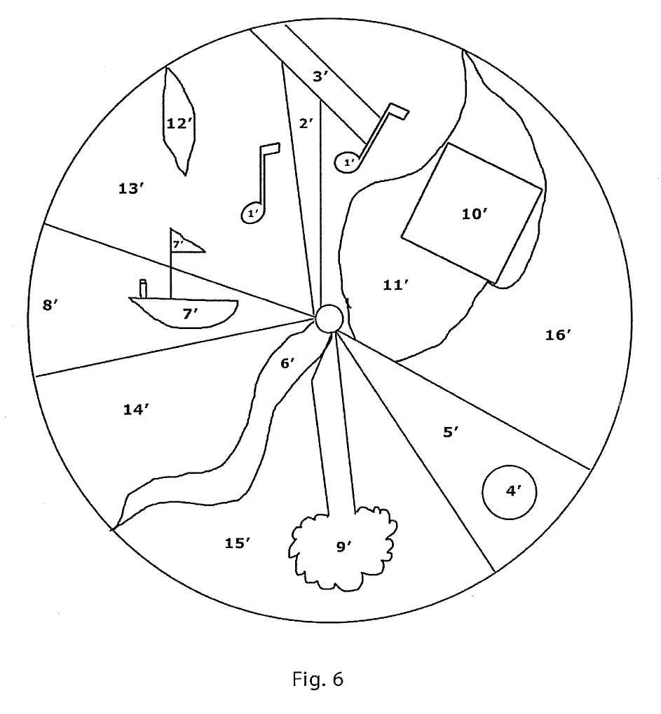

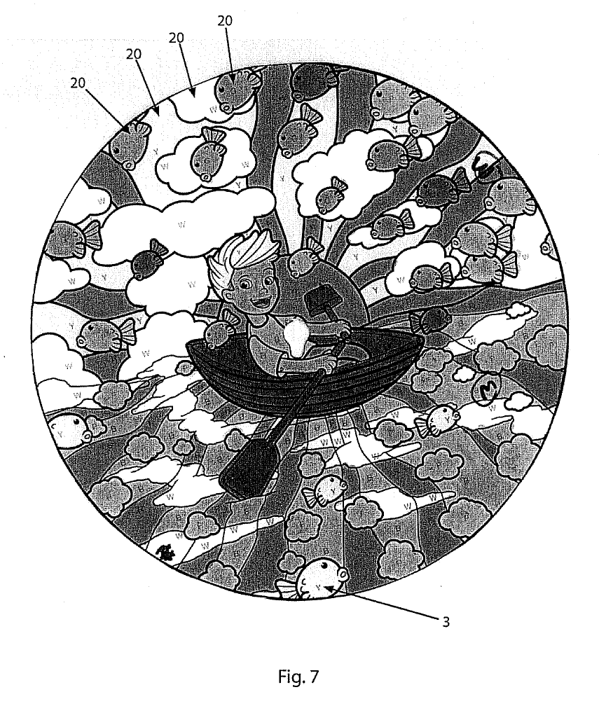

Referring now to FIGS. 5, 6, and 7; each is an example of a colored indicia substrate 3 containing a contiguous image having a plurality of identified regions (all respectively 20) shaped relative to center point 6A of substrate 3. As proposed in FIG. 5, the contiguous images form a balloon seller-man with an umbrella and top hat. As proposed in FIG. 6, the contiguous images form a series of segments, each containing a particular theme, from a boat theme to a woodland/tree theme with surrounding regions, depicted as 1′ through 16′ for later reference. As proposed in FIG. 7, the contiguous images form a number of fish surrounding a boat and rowing boy.

As will be appreciated by those of skill in the art having studied FIGS. 5, 6, and 7, a plurality of alternative contiguous images may be provided without departing from the scope and spirit of the present invention. Similarly, while the examples provided are sourced to a particular recognized musical tempo, the current inventive system also allows users to present a personally unique contiguous image from a plurality of identified regions 20, which when ‘played’ on the proposed system 1 will generate a user-desired musical sound quality. As a result, the proposed system 1 may be fully modified by a user or series of uses each developing their unique colored indicia substrate without departing from the scope and spirit of the present invention.

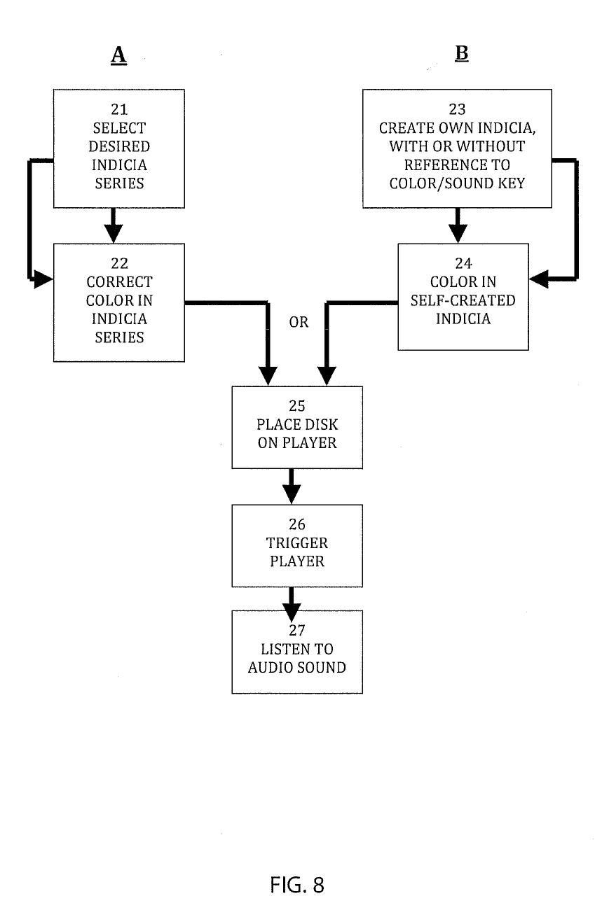

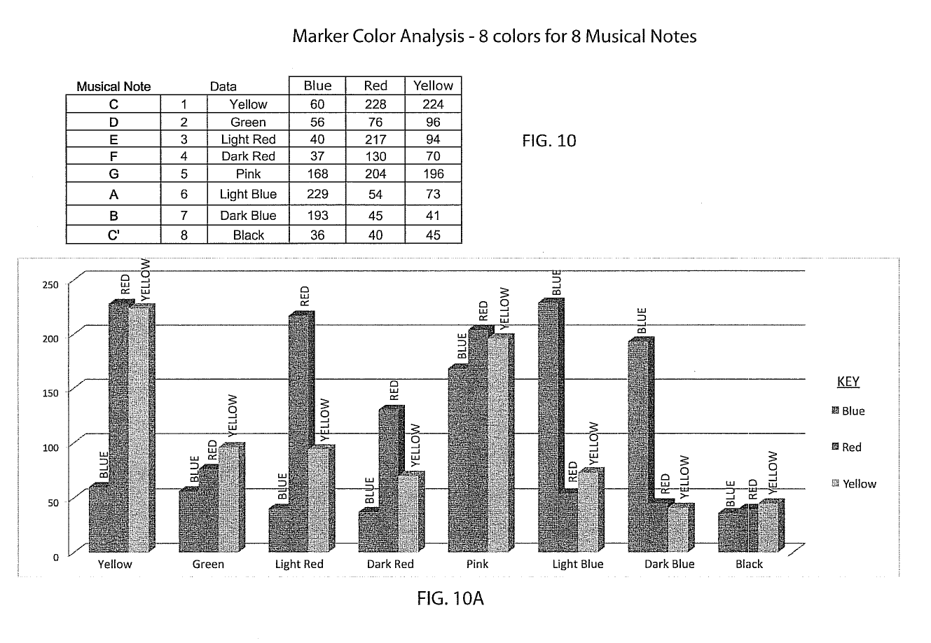

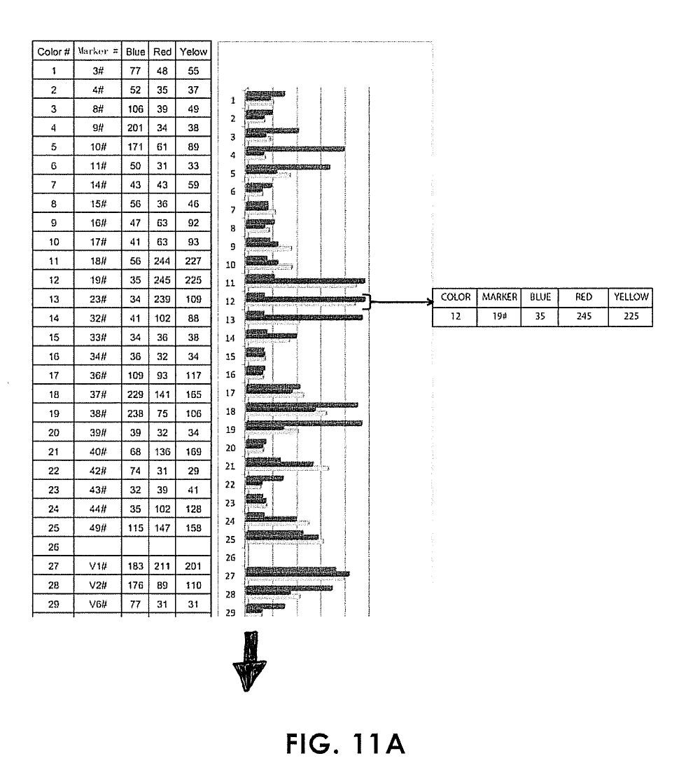

Referring now to FIG. 8, a graphical representation of operational alternatives is proposed. On a leftward side A, a user selects a desired indicia substrate 3 from a plurality of alternative indicia substrates at a step 21. At step 21, there is no color in the individual identified regions 20, although a series of related regions 20 may be colored a similar color to support a musical theme. In step 22, the user-desired color is entered on substrate 3 using a desired colored key such that a desired note may be played, or the indicia form a pleasing visual appearance. Thereafter, in a step 25, substrate 3 is placed on support disk 6 and on off switch 9 is triggered at step 26 causing motors 14, 15 to operate and the user listens to the sound generated at step 27. Alternatively, a user in a step 23 may create their own colored indicia substrate 3 without reference to a desired color or sound key (for example in FIG. 10), and simply forms a desired continuous image based on color desire. In a step 24, the user then colors substrate 3 as desires and follows steps 25, 26, and 27 to operate system 1.

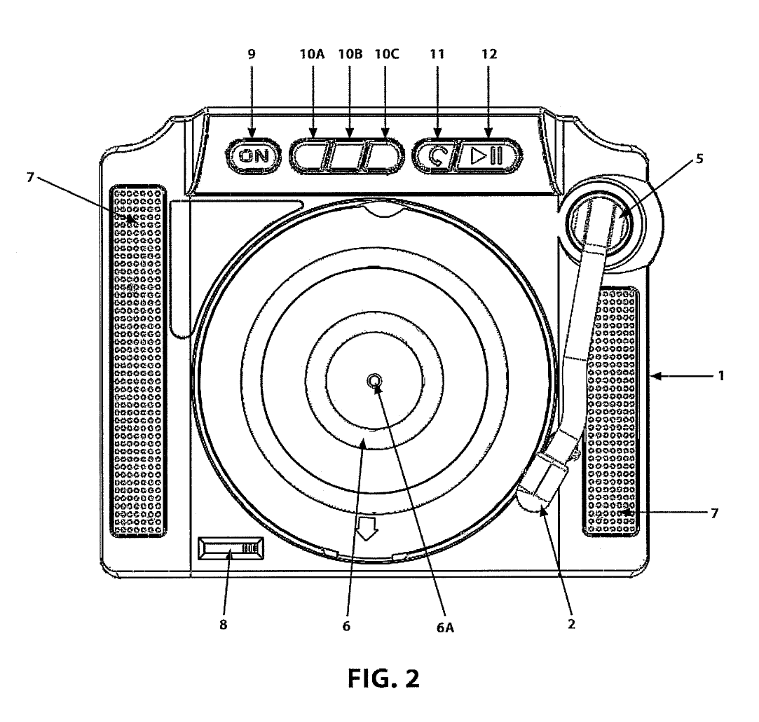

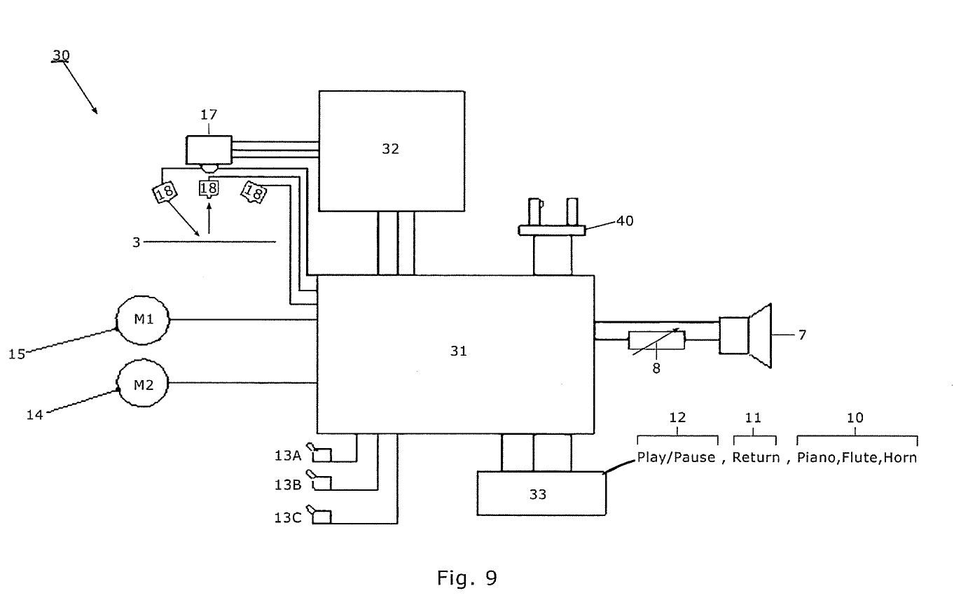

Referring now to FIGS. 9, 10, 10A, and 11, an exemplary electronic control circuit 30 is shown for effectuating operation of system 1. As indicated, a main control integrate circuit system 31 is in operative communication with an audio/digital converter 32, a series of control button inputs, collectively 33 (the control buttons noted in FIG. 2 discussed earlier), respective driving motors 14 and 15 for the arm return function and driving support disk 6 (as discussed earlier). As shown, the bandwidth limited LEDS 18, 18, and 18 are in operative control via direct connection with main control 31, and photo sensor 17 is in connection with A/D converter 32, such that received reflected light 35 resulting from incident light 36 reflected on measuring surface 19 is received by photo sensor 17 and converted from audio signals to a digital signal by A/D converter 32. As a result, a digital signal is received by main control IC 31 which serves as a processing and control circuit.

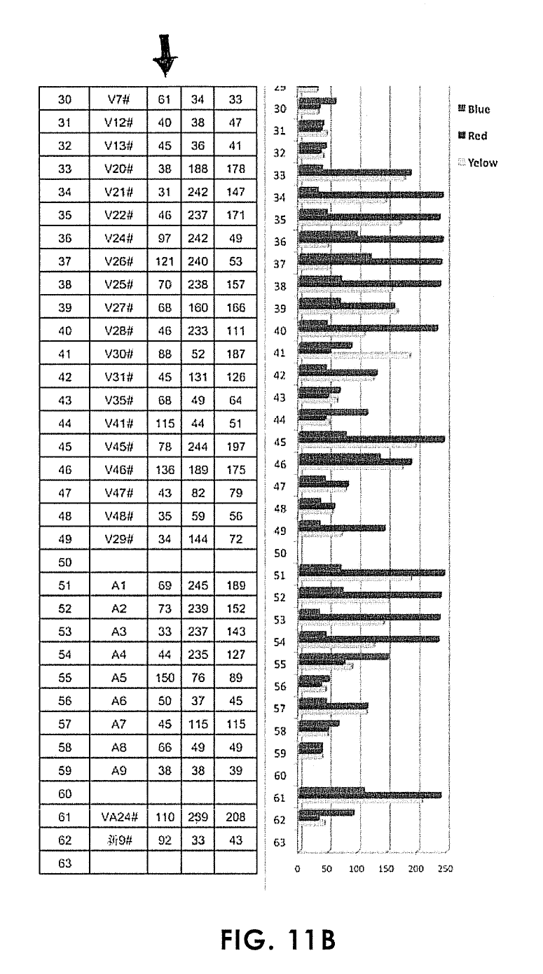

In main control IC 31 at least one color analysis key is presented (see FIGS. 10, 11, and 10A) enabling the series of received digital intensity signals to be compared for each three LED flashed sequence and a resultant data color recognized. Thereafter, as a result of recognizing the color data a data table is consulted, a musical note or audio file triggered), and the resultant audio or musical signal is transmitted to speakers 7. During operation, the three LED's will flash in a controlled rapid sequence (at least once per second, and preferably much faster) sot that the photo sensor 17 and main control 31 will recognize the resultant reflected light relating to each respective LED flash in each series set. By recognizing the resultant comparisons of each set of three LED sequence flashes, an intensity graphic (FIG. 10A or 11) may be consulted, a musical note or color recognized, and a resultant audio signal output. As can bee seen as a non-limiting example in FIG. 10A, the resultant color for ‘yellow’ is indicated as an intensity of reflected light of 50 for the blue LED flash, an intensity of 228 for the red LED flash, and an intensity of 224 for the yellow LED. As a result, and based upon the intensity of reflected intensities to specific wavelength limited to the selected LED. Using the proposed control circuit 30, light sensor 17 is not troubled by the continuous background light incident on colored indicia substrate 3, so that the device may be used in any conventional lighting condition, and indeed also in the dark.

During operation the three color LED's 18, 18, and 18 emit bandwidth-limited light onto the surface in a known sequence. Sensor 17 reads brightness or intensity data via the AID converter module 32 and the control IC 31 compares this intensity data with the database memory (in the IC but not shown) and determine a resultant musical note and play the note.

A photo interrupter 40 in operative communication with main control 31 is employed to control the color reading position of arm 2 during the arc swing motion of use. A series of leaf switches 13A, B, and C are used to control the control arm 2 and position of support disk 6, such that when arm 2 triggers a return switch, disk 6 stops driving and when a return switch is triggered control 31 recognizes the home position of arm 2.

A likely sequence of user-operation steps is as follows:
(1) Press the on/off button 9.
(2) Press the play/pause button 12; drive motor 15 (#1) and color sensor 17 begin operation and will work until we press the play/pause button 12 again to pause the motor and color sensor.
(3) When arm 2 reaches the end of it's arc and triggers leaf switch/sensor 13C (#2) the color sensor function 17 will be stopped.
(4) After a time, 1 second here, leaf switch/sensor 13C (#2) is triggered and motor 14 (#2) will start to work until reaching a base position determined by triggering leaf switch/sensor 13A (#1). When leaf switch/sensor 13A (#1) is triggered, motor 14 (#2) stops at once.
(5) Motor 15 (#1) will continuous work until leaf switch/sensor 13B(#3) is triggered). All functions ill be stopped until the play/pause button is pressed again.
(6) When pressing the return button 11, the function will be the same as the leaf switch/sensor 13C (#2) will be triggered, motor 14 (#2) will work after one second, and stop until reaching leaf switch/sensor 13A (#1), then Motor #1 will stop until leaf switch/sensor 13B (#3) is triggered.
(7) Leaf switch/sensor 13C (#2) will be triggered every turn by the turntable disk 6 in normal play, but will not work unless leaf switch/sensor 13C (#2) is triggered or the return button is pressed first.

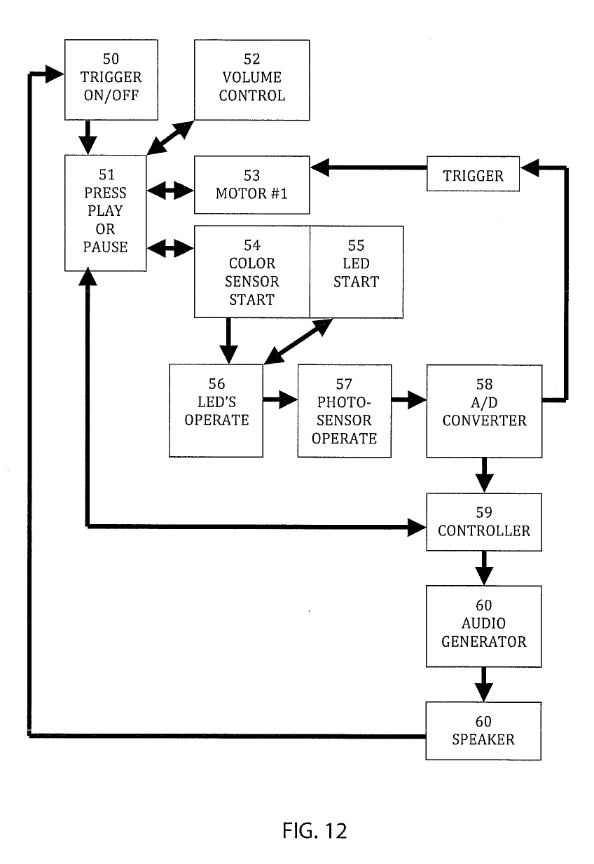

Referring now to FIG. 12, an alternative and optional sequence of events is described during a use of system 1. First at a step 50, on/off switch 9 is triggered, and at 51 a user presses play/pause button 12, at step 52 adjusts volume control unit 8 and steps 53, 54, and 55 triggers drive motor 15 (#1), colors sensor member 18 and LED light emitters 18. Thereafter, the LED's operate and photo sensors operate in steps 56 and 57 and supply intensity data to A/D converter 32 in step 58, which produces digital signals to the process controller 31 in a step 59. Step 59 via process controller 31 either triggers motor 15 to continuously run and/or additionally generates (via accessing memory modules and data tables) an audio signal generator at step 60, which in turn is output to speakers 7 in a step 60. As a consequence, those of skill in the art, having studied the proposed systems and options herein will now recognize that operative system 1 may be employed in various entertainment uses as a music generator and sound composer, wherein a user self-creates a unique colored indicia substrate based upon desired sounds and designated colored regions 20. For example, a different form of outer design may be provided for the row-boat-boy in FIG. 7, without departing from the scope and spirit of the present invention.

In view of the above, one of skill in the art of entertainment systems will recognize that both a system and a method of using the system or providing entertainment is provided. System 1 may be provided in any form effective to function generally to provide sound from a colored substrate wherein the coloring activity is provided by the user as an entertainment or for other purpose. Rotating substrate 3 may be in alternative forms of a rotating polygon, a long strip, or a series of polygons experiencing motion past a sensor and control circuit as discussed.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the drawings and specification, there have been disclosed typical embodiments of the invention and, although specific terms are employed, they are used in a generic and descriptive sense only and not for purposes of limitation, the scope of the invention being set forth in the following claims. To this end, the use of the phrase contiguous and continuous will be understood to be generally descriptive terms reflective of the types of designs seen in FIGS. 5, 6, and 7 where one or more related images and sequenced colors are arranged about a relative central point in any arrangement sufficient to operate with the proposed inventive system.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An electronic device, comprising:
(a) a housing member; said housing member containing a rotating support and means for driving said rotating support past a location containing a means for photo sensing a series of reflected sequenced light flashes resulting from a plurality of known wavelength-limited LED's outputting sequenced light incident on a colored substrate rotating on said rotating support during a use;
(b) a processing control module in said housing member, said processing control module:
(i) comprising a memory module containing a database for receiving timed sequenced intensity information in a series of sequences and comparing said timed sequenced intensity information to a stored table and selecting a reflective color designation; and
(ii) determining, from said reflective color designation a related musical note audio tone and generating an audio generation signal to said speaker to generate said output note; and
(c) at least one speaker system for receiving an audio generation signal and generating an output note.

2. An electronic device according to claim 1, said electronic device further comprising:
(a) a reader arm member containing said means for photo sensing;
(b) a first drive motor for operating said reader arm member in an arc relative to said rotating support and said colored substrate during a use thereof;
(c) a second drive motor for operating said rotating support during said use; and
(d) a plurality of trigger members interlinked with said processing control module and respective said first and second drive motors operating said electronic device during said use, whereby said entertainment system enables said entertainment use.

3. An entertainment system, comprising:
(a) a plurality of indicial substrates containing a plurality of color-indicating regions and for receiving a color designation during a coloring use thereof, and wherein each one of said plurality of indicial substrates contains a contiguous indicia designation different from others of said plurality of indicial substrates;
(b) a housing member, said housing member containing a rotating support and means for driving said rotating support past a location containing a means for photo sensing a series of reflected sequenced light flashes resulting from a plurality of known wavelength-limited LED's outputting sequenced light incident on a colored one of said indicial substrates rotating on said rotating support during a use;
(c) a processing control module in said housing member, said processing control module:
(i) comprising a memory module containing a database for receiving timed sequenced intensity information in a series of sequences and comparing said timed sequenced intensity information to a stored table and selecting a reflective color designation; and
(ii) determining, from said reflective color designation a related musical note audio tone and generating an audio generation signal to said speaker to generate said output note; and
(d) at least one speaker system for receiving an audio generation signal and generating an output note;

4. An entertainment system, according to claim 3, further comprising:
(a) a reader arm member containing said means for photo sensing;
(b) a first drive motor for operating said reader arm member in an arc relative to said rotating support and said colored substrate during a timed use thereof;
(c) a second drive motor for operating said rotating support during said use; and
(d) a plurality of trigger members interlinked with said processing control module and respective said first and second drive motors operating said electronic device during said use, whereby said entertainment system enables said entertainment use.

5. A method of generating a sound, said method comprising the steps of:
(a) providing an operating system containing a housing, a rotating support member on said housing, and a photo sensing system positioned proximate said rotating support member;
(b) providing in said photo sensing system at least one bandwidth limited LED for generating an incident known wavelength at a sequenced timing relative to a use thereof via a processor controller;
(c) providing said processor controller in operative control of said operating system, said rotating support, said photo sensing system and said at least one bandwidth limited LED, said process controller including an electronic memory for storing known reflected intensity measurements relative to received reflective light received by said photo sensing system;
(d) providing at least one colored indicia indicated substrate having a contiguous image thereon and a plurality of related regions for receiving external coloring thereon;
(e) coloring selected ones of said selected regions with said external coloring so as to faun a colored contiguous color indicia image thereon;
(f) placing said substrate on said rotating support;
(g) rotating said substrate on said rotating support past said photo sensing system and triggering said LED to generate a flashed sequenced known to said processor controller and receiving reflected intensity values from said flashed sequence; and
(h) converting said reflected intensity values to an audio note via access of a stored color/note data table and generating an audio digital signal to at least one speaker.
